(19) United States
(12) Patent Application Publication
(10) Pub. No.: US 2009/0129101 A1
(43) Pub. Date: May 21, 2009

(54) Apparatus and Method for Tool Free Wall Mount Installation of a Luminaire

(75) Inventors: James H. Bowden, JR., Tyrone, GA (US); Yefrim Rosovsky, Brooklyn, NY (US)

Correspondence Address: KING & SPALDING, 1180 PEACHTREE STREET , NE, ATLANTA, GA, 30309-3521, US

(73) Assignee: Cooper Technologies Company, Houston, TX (US)

(21) Appl. No.: 12/128,428

(22) Filed: May 28, 2008

Related U.S. Application Data
(60) Provisional application No. 60/932,163, filed on May 29, 2007.

(51) Int. Cl. F21V 21/08

(52) U.S. Cl. 362/371

(57) ABSTRACT

The wall mountable lighting fixture does not require tools to attach and remove the fixture from a wall surface. The wall mountable lighting fixture includes an attachment mechanism that can be manipulated from a first position to a second position by the push of a button. The button is pressed and the dimension of the attachment mechanism is increased and placed about the edges of a DIN rail attached to the wall. When the button is released, a biasing member returns the attachment mechanism to the first position, thereby reducing the dimension of the attachment mechanism. Once reduced, the dimension is smaller than the critical dimension of the DIN rail and either grips or rests within the DIN rail, thereby holding the fixture to the wall surface. Reversing the steps allows for the removal of the fixture from the wall for repair or replacement.

### RELATED PATENT APPLICATION

This patent application claims priority under 35 U.S.C. §119 to U.S. Patent Application No. 60/932,163, titled Apparatus For Tool Free Wall Light Installation, filed on May 29, 2007, the complete disclosure of which is hereby fully incorporated herein by reference.

### FIELD OF THE INVENTION

The present application relates generally to wall mountable lighting fixtures. Specifically, the present invention relates to wall mountable lighting fixtures that may be installed and removed without the use of tools.

### BACKGROUND OF THE INVENTION

Wall mountable lighting fixtures are a common feature of many buildings, especially ones where floor space is limited. An example of where wall mountable lighting fixtures are used include hospital patient rooms, where they are usually coupled to the wall in a manner that prevents the fixture from detaching accidentally. Common methods for securing wall mountable lighting fixtures include integrating the fixtures into the wall surface with a fastener such as a bolt, screw, adhesive, or other means known to those skilled in the art.

One problem with wall mountable lighting fixtures occurs when they must undergo routine maintenance. In order to perform maintenance, there are typically two choices. The first choice is to perform maintenance at the location of the wall mountable lighting fixture. A problem with that choice is that the maintenance might disrupt any activities in the surrounding area. A second choice involves removing the wall mountable lighting fixture from the wall surface and repairing it at a different location. As with on-site maintenance, this could disrupt activities in the area since the wall mountable lighting fixture removal would require the use of tools and someone of skill to decouple the fixture from the surface. The process of wall mounted lighting fixture removal may also be very time consuming, reducing the efficiency of the maintenance process. In addition, removal of the fixture may damage the wall surface and require repair thereto before the fixture can be reinstalled. Furthermore, repeated removal and reinstallation of the fixture can result in damage to the mounting elements of the fixture. Further, the area will not have a fixture during the maintenance period.

Therefore, a need exists for a wall mountable lighting fixture that may be installed and removed with a minimum of disruption to the surrounding area.

### SUMMARY OF THE INVENTION

The present invention relates generally to a wall mountable lighting fixture that can be toollessly installed or removed from a mounting surface. The wall mountable lighting fixture can be mounted on the DIN rail, and a latch can maintain the wall mountable lighting fixture in position once the wall mountable lighting fixture is attached as described below.

For one aspect of the present invention, the wall mountable lighting fixture can include a housing for a lamp. A first projection can be coupled to the housing and can be configurable to be releasably secured to a support member. The wall mountable lighting fixture can also include a mounting mechanism that is adjustable from a first position to a second position. The mounting mechanism can include a latch that is movably coupled to the housing such that the latch can be adjusted along one axis from the first position to the second position. A biasing member can be coupled to the latch and the housing and is able to maintain the latch in the first position when there is no external force being applied to the latch. The mounting mechanism can also include a second projection that can be coupled to the latch. The second projection can be releasably secured to the support member when the latch is adjusted from the first position to the second position and back again.

For another aspect of the present invention, a system for mounting a wall mountable lighting fixture to a surface includes attaching a support member, such as a DIN rail, to a surface. The wall mountable lighting fixture, substantially as described above, can be attached to the support member through the use of the first projection and the second projection by adjusting the position of the second projection relative to the first projection. The second projection may move when the latch moves from the first position to the second position and back again while positioning a portion of the wall mountable lighting fixture about the support member.

For yet another aspect of the present invention, a method for mounting a wall mountable lighting fixture to a surface includes providing a support member that is coupled to the surface. A wall mountable lighting fixture is provided and can be operable to be coupled and detached from the support member. The wall mountable lighting fixture can include a housing for a lamp. A first projection can be coupled to the housing and can be made to be releasably secured to a support member. The wall mountable lighting fixture can also include a mounting mechanism that is adjustable from a first position to a second position. The mounting mechanism can include a latch that is movably coupled to the housing such that the latch can be adjusted along one axis from the first position to the second position. A biasing member can be coupled to the latch and the housing and is able to maintain the latch in the first position when there is no external force being applied to the latch. The mounting mechanism can also include a second projection that can be coupled to the latch. The second projection can be releasably secured to the support member when adjusted from the first position to the second position and back again. A push-button can be positioned adjacent to the latch and configured to move the latch from the first position to the second position when a force is applied to the push button. The method further includes attaching the wall mountable lighting fixture to the support member.

These and other aspects, objects, and embodiments of the present invention will become apparent to those having ordinary skill in the are upon consideration of the following detailed description of illustrative embodiments exemplifying the best mode for carrying out the invention as presently perceived.

### BRIEF DESCRIPTION OF THE DRAWINGS

For a complete understanding of the present invention and the advantages thereof, reference is now made to the following description in conjunction with accompanying figures in which:

FIG. 1a is an exploded view of a tool free wall mountable lighting fixture according to one exemplary embodiment of the present invention;

FIG. 1b is a top-down view of the tool free wall mountable lighting fixture of FIG. 1a according to one exemplary embodiment of the present invention;

FIG. 1c is a side view of the tool free wall mountable lighting fixture of FIG. 1a according to one exemplary embodiment of the present invention;

FIG. 1d is a rear elevation of the tool free wall mountable lighting fixture of FIG. 1a according to one exemplary embodiment of the present invention;

FIG. 1e is a rear perspective view of the tool free wall mountable lighting fixture of FIG. 1a according to one exemplary embodiment of the present invention;

FIG. 2a is a perspective view of the interior of the tool free wall mountable lighting fixture according to one exemplary embodiment of the present invention;

FIG. 2b is a perspective view of the interior portion of the mounting mechanism for the tool free wall mountable lighting fixture according to one exemplary embodiment of the present invention;

FIG. 2c is a rear perspective view of the mounting side of the tool free wall mountable lighting fixture according to one exemplary embodiment of the present invention;

FIG. 3 is a perspective rear view of the exterior of the mounting side of the tool free wall mountable lighting fixture according to one exemplary embodiment of the present invention;

FIG. 4 is a perspective view of a latch bracket for the mounting mechanism of the tool free wall mountable lighting fixture according to one exemplary embodiment of the present invention;

FIG. 5 is a side cutaway view of the mechanism for the tool free wall mountable lighting fixture presenting the interaction between the latch bracket and the DIN rail according to one exemplary embodiment of the present invention;

FIG. 6 is a rear interior view of the mounting mechanism for the tool free wall mountable lighting fixture presenting the exemplary interaction between the housing, a torsion spring, and latch when in the first position according to one exemplary embodiment of the present invention; and

FIG. 7 is a rear interior view of the mounting mechanism for the tool free wall mountable lighting fixture presenting the exemplary interaction between the housing, a torsion spring, and latch when in the second position according to one exemplary embodiment of the present invention.

It is to be noted, however, that the appended drawings illustrate only typical embodiments of this invention and are therefore not to be considered limiting of its scope, as the invention may admit to other equally effective embodiments.

### DETAILED DESCRIPTION OF THE EXEMPLARY EMBODIMENTS

The present invention supports a method and apparatus for toollessly mounting and removing a wall mountable lighting fixture 100 from a wall or surface. The tool free wall mountable lighting fixture 100 is designed to be coupled to a mounting surface. Generally, the tool free wall mountable lighting fixture 100 is designed to be simple to operate while at the same time capable of being securely coupled to the mounting surface. Exemplary embodiments of the present invention can be more readily understood by reference to the accompanying figures.

It should be understood at the outset that although exemplary embodiments of the invention are illustrated below, the present invention may be practiced using any number of techniques, whether currently known or in existence. The present invention should in no way be limited to the exemplary implementations, drawings, and techniques illustrated below, including the exemplary design and implementation illustrated and described herein.

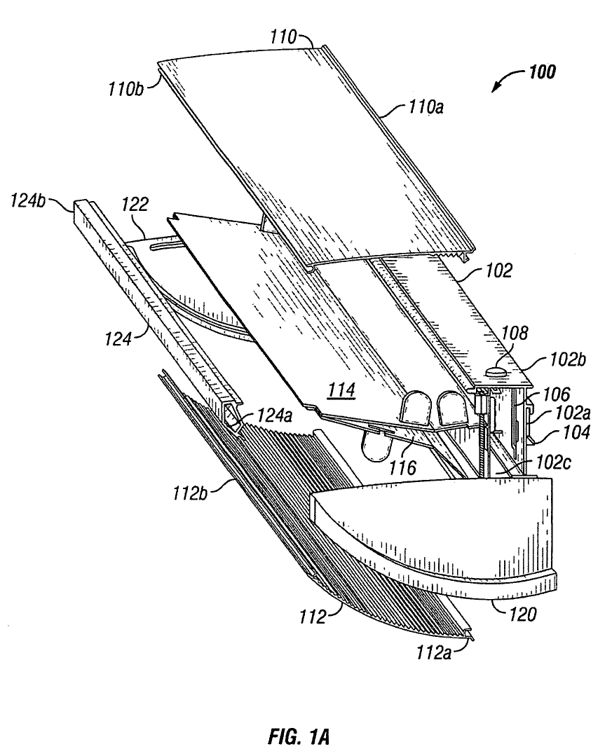

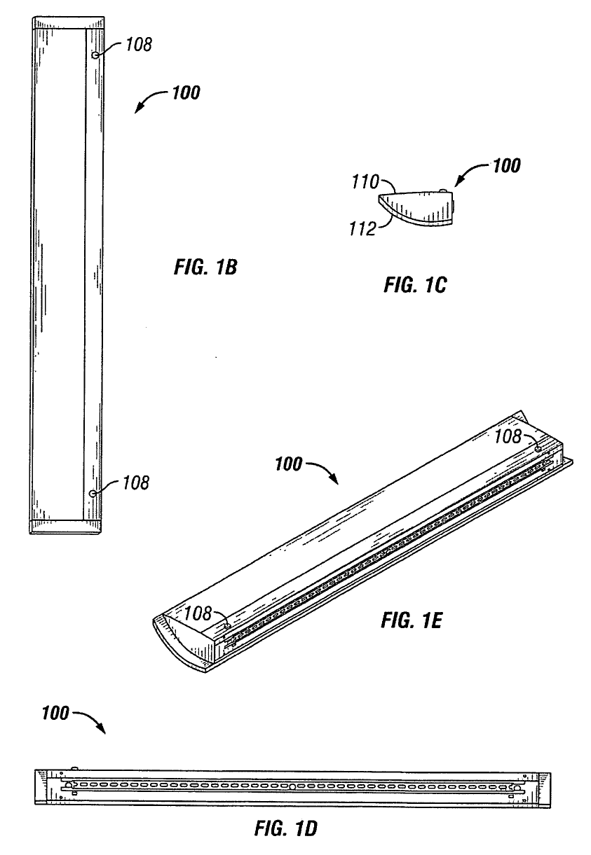

Referring now to the figures, in which like numerals represent like elements through the several figures, aspect of the several figures will be described. FIGS. 1a-1e present several assembly views of a tool free wall mountable lighting fixture 100 according to one exemplary embodiment of the present invention. Referring to FIGS. 1a-1e, the exemplary wall mountable lighting fixture 100 includes a mounting mechanism. In one or more exemplary embodiments, the mounting mechanism includes a back member 102 and one or more latch brackets 106, and one or more buttons 108. Optical components for the exemplary wall mountable lighting fixture 100 may include a top lens 110, a bottom lens 112, one or more lamps (not shown), an upper reflector 114, and a lower reflector 116. The exemplary housing includes the aforementioned back member 102, a left end cap 120, a right end cap 122, and a front extrusion 124.

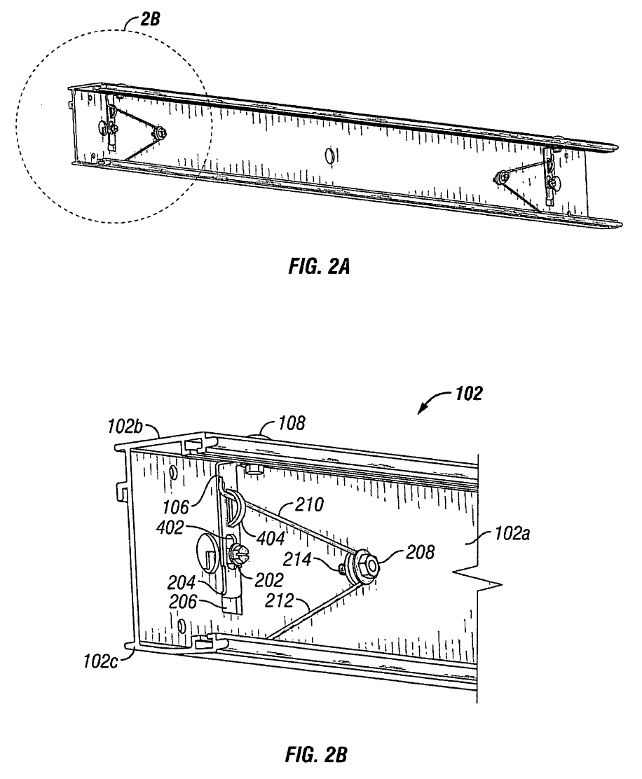

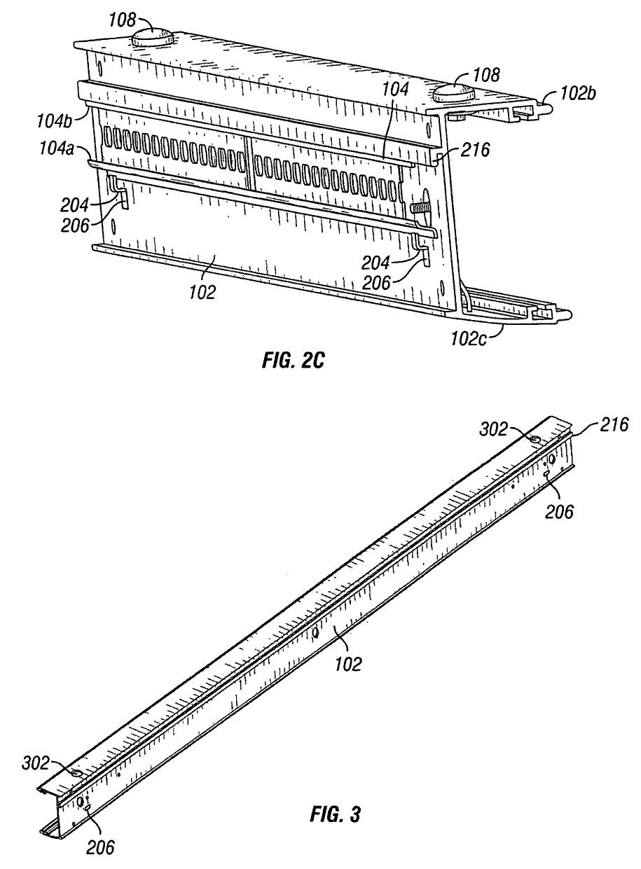

The exemplary back member 102 is an elongated member that includes a generally vertical member 102a having a top side and a bottom side and coupled along the top of the vertical member 102a to a generally horizontal upper member 102b having a front side and a back side and coupled along the bottom of the vertical member 102a to a generally horizontal lower member 102c having a front side and a back side. In one exemplary embodiment, the top side of the vertical member 102a is coupled generally along the back side of the horizontal upper member 102b and the bottom side of the vertical member 102a is coupled generally along the back side of the horizontal lower member 102c. In one exemplary embodiment, the horizontal and vertical members 102a-c can be integrally formed from a single piece of material, such as metal or plastic. In an alternative embodiment, the horizontal and vertical members 102a-c can be individually formed and then coupled to one another by known coupling means, such as welding, fasteners or adhesives. In one exemplary embodiment, the back member 102 is made of extruded aluminum. The back member 102 also includes one or more latch brackets 106 and one or more latch buttons 108 which will be described in greater detail with reference to FIGS. 2a-c and 4.

The wall mountable lighting fixture 100 also includes a bottom lens 112. The exemplary bottom lens 112 has an elongated shape and is radiused about the lamp. The bottom lens 112 includes a first attachment tab 112a extending along one elongated edge of the lens 112 and releasably coupled to the front side of the lower horizontal member 102c. The bottom lens also includes a second attachment tab 112b extending along another elongated edge of the lens 112 and releasably coupled to a bottom edge 124a of the front extrusion 124. In one exemplary embodiment, the bottom lens 112 is snap-fitted between the front extrusion 124 and the lower horizontal member 102c.

The wall mountable lighting fixture 100 further includes a top lens 110 having an elongated shape that extends substantially the entire length of the wall mountable lighting fixture 100. The top lens 110 includes a back attachment tab 110a that is releasably coupled to the front side of the upper horizontal member 102b and a front attachment tab 110b that is releasably coupled to the top edge 124b of the front member 124. In one exemplary embodiment, the top lens 110 is snap-fitted between the front member 124 and the upper horizontal member 102b. In one exemplary embodiment, the top lens 110 and bottom lens 112 may be made from a thick, clear prismatic acrylic lens where the thickness varies on the prism profile and the prisms are located on the inside for easy cleaning. The lamp (not shown) in the exemplary embodiment is a linear florescent lamp. In one exemplary embodiment, the front extrusion 124 is made of extruded aluminum.

The wall mountable lighting fixture 100 further includes a left end cap 120 releasably coupled generally along one side of the back member 102 and the front member 124. The device also includes a right end cap 122 releasably coupled generally along the opposing side of the back member 102 and the front member 124. In one exemplary embodiment, the left end cap 120 and the right end cap 122 are made of die cast metal. The device also includes one or more reflectors, such as the upper reflector 114 and lower reflector 116 positionable between the back member 102, front member 124, bottom lens 112, top lens 110 and the end caps 120, 122. The reflectors focus, enhance and distribute the light from the lamp in the desired direction and intensity.

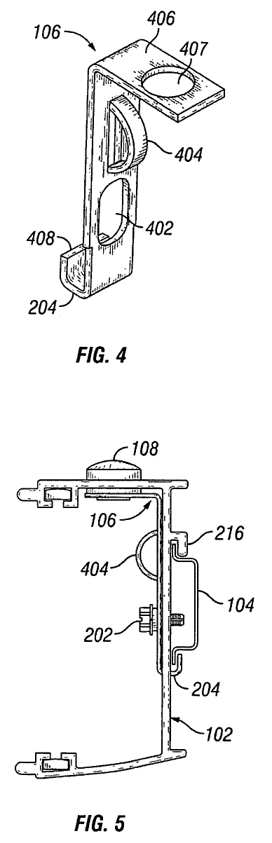

FIGS. 2a-c present several views of the mounting mechanism for the wall mountable lighting fixture 100 according to one exemplary embodiment of the present invention. FIG. 4 presents another side cutaway view of the mounting mechanism according to one exemplary embodiment of the present invention. Now referring to FIGS. 2a-c and 4, the exemplary mounting mechanism for the wall mountable lighting fixture 100 includes a latch bracket 106 movably coupled to the interior of the vertical member 102a of the back member 102. In one exemplary embodiment, the latch bracket 106 includes a latch aperture 402 through which a screw 202 movably couples and maintains the alignment of the latch bracket 106 to the back member 102. The screw 202 allows the latch bracket 106 to move in the vertical plane with respect to the back member 102.

The latch bracket 106 includes a latch bracket tab 204 that extends substantially orthogonal to the latch bracket 106 and outside the back member 102 though a tab aperture 206 that is positioned on the vertical member 102a. The latch bracket 106 also includes an extension 406 (see FIG. 4) that is generally orthogonal to the latch bracket 106 and is positioned along the top of the latch bracket 106. The extension 406 is generally positioned adjacent to the upper horizontal member 102b of the back member 102. In one exemplary embodiment, the extension 406 includes a button aperture 407 for receiving a portion of a button 108. In an alternative embodiment, the button 108 can be coupled or releasably coupled to the extension 406 by known coupling methods, including, but not limited to, screws, welding, and adhesives.

The button 108 is positioned to extend outside of the upper horizontal member 102b through a button aperture 302. While the exemplary embodiment shown and described positions the button 108 along the top of the wall mountable lighting fixture 100, those of ordinary skill in the art will recognize that the elements described herein could be reorganized such that, the button 108 could be positioned along the bottom of the wall mountable lighting fixture 100, such as through the lower horizontal member 102c, or along the sides of the wall mountable lighting fixture 100, such as through one or both of the end caps 120, 122.

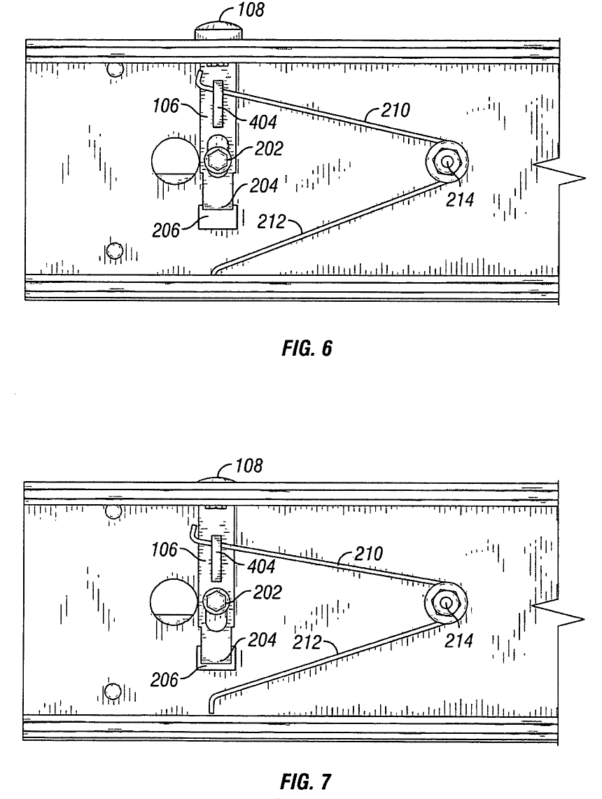

The latch bracket 106 and its associated latch bracket tab 204, extension 406, and button 108 may alternate between a first position, as shown in FIG. 6, and second position, as shown in FIG. 7, when the button 108 is depressed, due to the interaction between the latch bracket 106 and the screw 202, thereby moving the latch bracket tab 204 downward to provide a greater distance between the latch bracket tab 204 and a fixed notch 216. As shown in FIG. 2c, the DIN rail 104 interacts with the back member 102 at the fixed notch 216 coupled to the back member 102 and the latch bracket tabs 204. The lower DIN rail edge 104a opposing the upper DIN rail edge 104b that interfaces with the fixed notch 216 and with the latch bracket tab 204. In the exemplary embodiment of FIG. 2c, the latch bracket tabs 204 are shown in the first position, securing the wall mountable lighting fixture 100 to the DIN rail 104.

Attached to the latch bracket 106 is a biasing member. In one exemplary embodiment, the biasing member is a torsion spring 208 with two ends. The torsion spring first end 210 is releasably coupled to the latch bracket 106 and projects towards the button 108. In one exemplary embodiment, the torsion spring first end 210 is positioned through a belt loop or eyelet 404 that is coupled to the latch bracket 106 and extends outward therefrom in a semi-circular pattern. However, those of ordinary skill in the art will recognize that the precise shape of the belt loop 404 can be modified to several different shapes and in an alternative embodiment, the torsion spring first end 210 may be coupled to the latch bracket 106 using other known attachment methods including, but not limited to, welding, screws, rivets and the like. The torsion spring 208 then extends around a securing member 214, such as a lock nut, screw, or bolt, coupled to the back member 102. The torsion spring second end 212 extends from the securing member 214 to a surface of the back member 102 in such a manner that it extends away from the button 108 and provides the necessary biasing force to maintain the latch bracket tab 204 in the first position until a force is applied to the latch button 108.

The torsion spring 208 acts on the latch bracket 106 maintain the latch bracket 106 in the first position, as shown in FIG. 6, absent external forces. In the event an external force is applied, typically to the button 108, sufficient to overcome the force from the torsion spring 208, the button 108 will enter second position, as shown in FIG. 7. As a result of their fixed relationship, the latch bracket 106 will enter second position along with the latch bracket tab 204. Once the external force is removed, the torsion spring 208 will force the latch bracket 106, latch bracket tab 204 and the button 108 to return to the first position. This function will be elaborated below.

FIG. 3 is a perspective rear view of the length of the mounting side of the back member 102 independent of the other components, according to one exemplary embodiment of the present invention. Referring now to FIG. 3, the back member 102 contains two main openings for the latch bracket 106 to operate. The first opening is the button aperture 302 that allows the button 108 to extend through the upper horizontal member 102b and into the back member 102. The second set of opening are the tab apertures 206 that allow the latch bracket tab 204 from the latch bracket 106 to extend through the vertical member 102a and outside of the back member 102. FIG. 3 also presents another view of the fixed notch 216 extending along the length of the vertical member 102a. While the exemplary embodiment shows the fixed notch 216 extending along substantially the fill length of the vertical member 102a, in alternative embodiments the fixed notch 216 can extend along only a portion of the vertical member 102a or can be split into multiple sections that are positioned substantially vertically in line with corresponding latch bracket tabs 204

FIG. 4 is a perspective view of the latch bracket 106 of the wall mountable lighting fixture 100 according to an exemplary embodiment. The latch bracket 106 includes a latch aperture 402 that is capable of receiving a screw 202 (of FIG. 2c) and that allows the latch bracket 106 to interact with the screw 202. This interaction allows the latch bracket 106 to move vertically from the first position to the second position, but restricts lateral movement of the latch bracket 106. Above the latch aperture 402 is the belt loop 404. In one exemplary embodiment, the belt loop 404 allows the torsion spring 208 (of FIG. 2c) to interface with the latch bracket 106 as described above.

As described above, the latch bracket 106 also includes the extension 406 which extends substantially orthogonal to the latch bracket 106 and is positioned adjacent to the upper horizontal member 102b (of FIG. 1a). In one exemplary embodiment, the extension 406 includes a button aperture 407, which is capable of being releasably coupled to or capable of receiving the button 108 (of FIG. 1a). On the opposing end of the latch bracket 106 is the latch bracket tab 204. This latch bracket tab 204 is configured to extend substantially orthogonally and horizontally from the latch bracket 106 and can include an upturned latching member 408 on its distal end. In one exemplary embodiment, the latching member 408 is substantially orthogonal to the latch bracket tab 204 and substantially parallel with the latch bracket 106.

FIG. 6 is a rear interior view of the wall mountable lighting fixture 100 with the mounting mechanism in the first position. FIG. 7 is a rear interior view of the wall mountable lighting fixture 100 with the mounting mechanism in the second position. Referring now to FIGS. 6 and 7, an exemplary method for installing the wall mountable lighting fixture 100 can be shown and described. A user can install a mounting rail, such as the DIN rail 104 (of FIG. 1) to a wall, ceiling, or other surface. The user can take the device with the mounting mechanism in the first position and align the wall mountable lighting fixture 100 with the DIN rail 104. The fixed notch 216 (of FIG. 3) can be positioned between the top edge 104b of the DIN rail 104 and the surface, while holding the wall mountable lighting fixture 100 such that the vertical member 102a is angularly disposed from the surface. The user can then depress the latch button 108 to move the button 108, latch bracket 106, latch bracket tab 204 and latching member 408 from the first position (of FIG. 6) to the second position (of FIG. 7). This movement from the first position to the second position allows the wall mountable lighting fixture 100 to be placed on the DIN rail 104 by allowing enough space between the latch bracket tab 204 and the fixed notch 216 to move the wall mountable lighting fixture 100 over the DIN rail 104.

Once the latch bracket 106 is in the second position, the wall mountable lighting fixture 100 can be rotated about the DIN rail 104 such that the vertical member 102a is substantially vertical and the fixed notch 216 and the latching member 408 are substantially adjacent to the surface. In this position, the fixed notch 216 remains between the top edge 104b of the DIN rail 104 and the surface and the latching member 408 is positioned between the bottom edge 104a of the DIN rail 104 and the surface. The user then releases the pressure on the button 108, allowing the torsion spring 208 to automatically return the button 108, latch bracket 106, latch bracket tab 204 and latching member 408 substantially to the first position, thereby holding the mounting mechanism, and the corresponding wall mountable lighting fixture 100 to the surface by way of the DIN rail. Removing the wall mountable lighting fixture 100 from the surface can be completed by reversing the steps above, thereby allowing the attachment and removal of a wall mountable lighting fixture 100 to a wall or other surface without the need for tools.

In an alternative embodiment, it may be possible to slide the wall mountable lighting fixture 100 onto the DIN rail 104 without the need to press the button 108. This may be accomplished by using an angled member on the DIN rail 104 that acts on the latch bracket tab 204 which forces the latch bracket 106 into the second position by overcoming the force of the biasing element on the latch bracket 106 until the wall mountable lighting fixture 100 is positioned on the DIN rail 104. Once the latch bracket tab 204 has passed the angled member, the latch bracket tab 204 returns to first position, securing the wall mountable lighting fixture 100 to the DIN rail 104.

Additional features include the use of lamps (not shown) in the wall mountable lighting fixture 100. In one exemplary embodiment, there are multiple lamp orientations. These orientations are facilitated by a combination of the lamps and reflectors used. One lamp may illuminate in a fixed direction suitable for reading or other localized functions. A second lamp may provide more diffused illumination designed to illuminate a room.

As described herein, the present invention is well adapted to attain the ends and advantages mentioned, as well as those inherent therein. The particular embodiments above are illustrative only, as the present invention may be modified and practiced in different but equivalent manners apparent to those having ordinary skill in the art having the benefit of the teachings provided herein. Having described some exemplary embodiments of the present invention, it is believes that the used of alternate inputs connectors or output connectors is within the purview of those having ordinary skill in the art.

Any spatial references herein such as, for example, “top,” “bottom,” “upper,” “lower,” “above,” “below,” “rear,” “between,” “vertical,” “angular,” “beneath,” etc., are for the purpose of illustration only and do not limit the specific orientation or location of the described structure.

While numerous changes may be made by those having ordinary skill in the art, such changes are encompassed within the spirit and scope of this invention as defined by the appended claims. Furthermore, no limitations are intended to the exemplary details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicit and clearly defined by the patentee.

What is claimed is:

1. A lighting device for toollessly mounting to a support member on a surface, comprising:
a housing;
a first projection coupled to the housing and configured to be releasably secured to the support member;
a mounting mechanism adjustable from a first position to a second position and comprising:
a latch movably coupled to the housing;
a biasing member coupled to the latch and configured to maintain the latch in the first position; and
a second projection coupled to the latch, wherein the latch releasably secures the second projection to the support member;
wherein the first projection and the second projection secure the lighting device to the support member.

2. The lighting device of claim 1, wherein the first projection is integrally formed with the housing.

3. The lighting device of claim 1, wherein the first projection comprises an L-shaped member coupled to the housing and extending substantially the length of the housing.

4. The lighting device of claim 1, further comprising a plurality of mounting mechanisms, wherein the first projection comprises a plurality of L-shaped members coupled to the housing, each L-shaped member substantially aligned with one of the second projections of the plurality of mounting mechanisms.

5. The lighting device of claim 1, further comprising a push-button configured to engage the latch and move the mounting mechanism from the first position to the second position when a force is applied to the push-button, wherein at least a portion of the push-button extends through the housing and is adjustable from an exterior of the housing.

6. The lighting device of claim 1, wherein the second projection is integrally formed with the latch.

7. The lighting device of claim 1, wherein a first portion of the biasing member is coupled to the latch and a second portion of the biasing member is coupled to the housing.

8. The lighting device of claim 1, wherein the biasing member comprises a torsion spring.

9. The lighting device of claim 1, wherein the biasing member comprises a coil spring.

10. The lighting device of claim 1, wherein the housing comprises:
a first member having a first end and a second end;
a second member substantially orthogonal to the first member and coupled to the first end;
a third member substantially orthogonal to the first member and coupled to the second end.

11. The lighting device of claim 10, wherein the latch comprises:
a first elongated member comprising a first end, a second end, and a first aperture therebetween, wherein the first elongated member is positioned substantially parallel with the first member and wherein the first aperture is configured to receive a device for maintaining motion of the latch along a single axis;
a second elongated member substantially orthogonal to the first elongated member and coupled to the first end of the first elongated member and comprising a second aperture for receiving a portion of a push button configured to move the latch from the first position to the second position; and
the second projection coupled to the second end of the first elongated member, wherein a portion of the second projection extends through an aperture in the first member.

12. The lighting device of claim 1, further comprising:
an upper lens releasably coupled to the housing;
a lower lens releasably coupled to the housing;
at least one reflector positioned within the housing; and
a lamp, positioned within the housing and between the upper lens and the lower lens.

13. A system for mounting a lighting device to a surface, comprising:
at least one support member coupled to a surface;
at least one lighting device operable to be releasably coupled to the at least one support member, the at least one lighting device comprising:
a housing;
a first projection coupled to the housing and configured to be releasably secured to a portion of the at least one support member;
a mounting mechanism adjustable from a first position to a second position and comprising:
a latch movably coupled to the housing;
a biasing member coupled to the latch and the housing and configured to maintain the latch in the first position; and
a second projection coupled to the latch, wherein the latch releasably secures the second projection to another portion of the support member;
wherein the first projection and the second projection secure the at least one lighting device to the support member.

14. The system of claim 13, wherein said first projection is integrally formed with said housing.

15. The system of claim 13, wherein the first projection comprises an L-shaped member coupled to the housing and extending substantially the length of the housing.

16. The system of claim 13, wherein the biasing member comprises a torsion spring.

17. The system of claim 13, further comprising a push-button configured to engage the latch and move the mounting mechanism from the first position to the second position when a force is applied to the push-button, wherein at least a portion of the push-button extends though the housing and is adjustable from an exterior of the housing.

18. The system of claim 13, wherein the housing comprises:
a first member having a first end and a second end;
a second member substantially orthogonal to the first member and coupled to the first end;
a third member substantially orthogonal to the first member and coupled to the second end.

19. The system of claim 18, wherein the latch comprises:
a first elongated member comprising a first end, a second end, and a first aperture therebetween, wherein the first elongated member is positioned substantially parallel with the first member and wherein the aperture is configured to receive a device for maintaining motion of the latch along a single axis;
a second elongated member substantially orthogonal to the first elongated member and coupled to the first end of the first elongated member and comprising a second aperture for receiving a portion of a push button configured to move the latch from the first position to the second position; and
the second projection coupled to the second end of the first elongated member, wherein a portion of the second projection extends through an aperture in the first member.

20. The system of claim 13, further comprising:
an upper lens releasably coupled to the housing;
a lower lens releasably coupled to the housing;
at lease one reflector positioned within the housing; and
a lamp, positioned with the housing and between the upper lens and the lower lens.

21. The system of claim 13, wherein the support member comprises a DIN rail.

22. A method for mounting a lighting device to a surface, comprising:
providing a support member coupled to a surface;
providing a lighting device operable to be releasably coupled to the support member, the lighting device comprising:
a housing;
a first projection coupled to the housing and configured to be releasably secured to a portion of the support member;
a mounting mechanism adjustable from a first position to a second position, the mounting mechanism comprising:
a latch movably coupled to the housing;
a biasing member coupled to the latch and the housing and configured to maintain the latch in the first position;
a second projection coupled to the latch, wherein the latch releasably secures the second projection to another portion of the support member; and
a push-button configured to engage the latch and move the mounting mechanism from the first position to the second position when a force is applied thereto, wherein at least a portion of the push-button extends though the housing and is accessible from an exterior of the housing; and
coupling the lighting device to the support member.

23. The method of claim 22, wherein coupling the lighting device to the support member comprises the steps of:
positioning the first projection between a portion of the support member and the surface;
providing a force against the push-button thereby adjusting the mounting mechanism from the first position to the second position, wherein the distance between the first projection and the second projection is greater in the second position than in the first position;
rotating the lighting device to position second projection between another portion of the support member and the surface; and
releasing the force against the push-button, thereby allowing the biasing member to adjust the mounting mechanism from the second position to substantially the first position, wherein the first projection and the second projection are coupled to the support member.

24. The method of claim 23, further comprising coupling the support member to a wall.
